(19) United States
(12) Patent Application Publication
(10) Pub. No.: US 2006/0267544 A1
(43) Pub. Date: Nov. 30, 2006

(54) Standard battery with tag

(75) Inventors: Andras Montvay, Aachen (AT); Jens Muhlsteff, Aachen (DE); Harald Reiter, Aachen (DE); Ralf Schmidt, Aachen (DE); Olaf Such, Aachen (DE); Josef Lauter, Gellenkirchen (DE)

Correspondence Address: PHILIPS ELECTRONICS NORTH AMERICA CORPORATION;INTELLECTUAL PROPERTY & STANDARDS, 1109 MCKAY DRIVE, M/S-41SJ, SAN JOSE, CA, 95131, US

(73) Assignee: Koninklijke Philips Electronics N.V., BA Eindhoven (NL)

(21) Appl. No.: 10/548,478

(22) PCT Filed: Mar. 8, 2004
(86) PCT No.: PCT/IB04/50210

§ 371 Date: Sep. 7, 2005

(30) Foreign Application Priority Data
Mar. 10, 2003 (EP) 03100590.3

(51) Int. Cl. H02J 7/00

(52) U.S. Cl. 320/106

(57) ABSTRACT

A battery configuration (1, 23, 24, 25, 26, 27) comprises a standard battery (AA, CR) of a standard type of battery and a tag (2, D). By inserting the battery configuration (1, 23, 24, 25, 26, 27) in any apparatus, the apparatus can be designed to communicate with a communication device (14, 25, 16, 22).

The invention relates to a battery configuration having at least one battery and a tag, connected to the at least one battery, for storing an identification information item.

The invention further relates to a packing unit for a battery configuration having at least one battery and a tag, connected to the at least one battery, for storing an identification information item.

The invention further relates to a sales unit for selling an apparatus having a communication device by means of which it is possible to identify a user of the apparatus, comprising

the apparatus having the communication device and

a battery configuration having a battery and a tag, connected to the battery, for storing an identification information item.

The invention further relates to a provision method for providing an apparatus having a communication device by means of which it is possible to identify a user of the apparatus.

The invention further relates to an identification method for identifying a user of a product.

Such a battery configuration is known from the document US2002/0041175 and is formed by a rechargeable battery, or an accumulator, of a mobile telephone, on which a tag for contactless communication is fitted. The tag is formed by a controller and an antenna and is designed for contactless communication with a communication device. There are a large number of different communication standards (e.g. Bluetooth, ISO14.443, ISO15.693, etc.) in which data is communicated between the tag and the communication device in different frequency ranges and accordingly different communication protocols.

US2002/0041175 discloses an implementation in which a manufacturer of a mobile telephone offers a number of different accumulators for this mobile telephone which, although they have the same mechanical dimensions, have in each case different tags fitted on them, which tags communicate according to different communication standards. This means that a mobile telephone having the respectively suitable accumulator (tag) can exchange data with a large number of communication devices communicating according to different communication standards.

In the implementation described above, it has proven to be disadvantageous that the mechanical dimensions and electrical specifications of the accumulators of various types of mobile telephone almost always differ, and the user of a mobile telephone must therefore consider whether the manufacturer of the mobile telephone offers, for his mobile telephone, an appropriate type of accumulator together with tag for communication in accordance with a specific communication standard. For manufacturers of mobile telephones, the generation, storage and supplying of end customers with a number of different types of accumulator that has increased substantially on account of the different types of tag is very expensive.

It is an object of the invention to provide a battery configuration of the type mentioned in the first paragraph, a packing unit of the type mentioned in the second paragraph, a sales unit of the type mentioned in the third paragraph, a provision method of the type mentioned in the fourth paragraph and an identification method of the type mentioned in the fifth paragraph, in which the above-described disadvantages are avoided. To achieve the object mentioned above, such a battery configuration is characterized in that the battery is formed by a standard battery of a commercially available standard type of battery.

To achieve the object mentioned above, such a packing unit is characterized in that the battery is formed by a standard battery of a commercially available standard type of battery.

To achieve the object mentioned above, such a sales unit is characterized by the following features:

sales unit for selling an apparatus having a communication device by means of which it is possible to identify a user of the apparatus, comprising

the apparatus having the communication device and

a battery configuration having at least one standard battery of at least one commercially available standard type of battery and a tag, connected to the battery, for storing an identification information item, wherein the at least one standard battery is provided for supplying a product of the user with power and the tag connected to the standard battery is provided to identify the user of the apparatus during communication with the communication device.

To achieve the object mentioned above, such a provision method is provided with the following steps:

provision method for providing an apparatus having a communication device by means of which it is possible to identify a user of the apparatus, wherein the following steps are carried out:

provision of a sales unit which comprises the apparatus that is to be provided and a battery configuration, wherein the battery configuration comprises at least one standard battery of at least one commercially available standard type of battery and a tag, assigned to the standard battery, for storing an identification information item;

delivery of the sales unit to the future user of the apparatus;

insertion of the at least one standard battery into a product of the user of the apparatus, in order to make it possible to identify the user of the apparatus during communication between the communication device of the apparatus and the tag assigned to the standard battery, on the basis of the identification information item that can be stored in the tag.

To achieve the object mentioned above, such an identification method is provided with the following steps:

identification method for identifing a user of a product, wherein the following steps are carried out:

purchasing of a battery configuration by the user, wherein the battery configuration comprises at least one standard battery of at least one commercially available standard type of battery, which can be inserted into the product, and a tag, connected to the standard battery, for storing an identification information item;

insertion of the at least one standard battery into the product, in order to supply the product at least temporarily with power from the standard battery;

identification of the user of the product during communication between a communication device and the tag assigned to the standard battery, on the basis of an identification information item that can be stored in the tag.

Standard batteries of a commercially available standard type of battery can be used in a large number of apparatuses or products and, on account of the tags fitted to these standard batteries, all these apparatuses or products can be designed for communication/identification with a communication device. A user can thus advantageously equip any of his apparatuses (e.g. watch, pocket calculator, PDA, remote control, flashlight, etc.) with a battery configuration according to the invention and use it for communication/identification with a communication device. The user thus does not need to use and also carry around with him any of the identification devices usually supplied for such applications (e.g. smartcard with tag, ring with tag, ski pass with tag, special watch with tag, electronic key with tag, etc.), but rather can use for this purpose an apparatus that is agreeable to the user.

According to the measures of claim 2, the advantage is obtained that the tag of the battery configuration can be placed at least temporarily in an active operating state, in which the tag is supplied with power from the standard battery, as a result of which, in the event of contactless communication, a substantially larger communication range is achieved.

According to the measures of claim 3, the advantage is obtained that the tag can communicate with communication devices both over a contactless communication interface and over a communication interface requiring contact. As a result there are many varied application possibilities.

According to the measures of claim 4, the advantage is obtained that, at the end of the process of manufacturing a commercially available standard battery, in an additional manufacturing step the tag can be stuck to the casing of the standard battery for example by means of an adhesive film. In the event of a tag communicating contactlessly, in order to achieve a large communication range it is advantageous to attach the tag to the outer wall of the casing of the standard battery, since the casing in this case does not screen the electromagnetic field.

According to the measures of claims 5 and 10, the advantage is obtained that for example four standard batteries are packed together in each packing unit, wherein one of the standard batteries is connected to a tag. This is advantageous, therefore, since in most apparatuses more than just one standard battery has to be used and one tag per apparatus is sufficient for communication/identification purposes.

According to the measures of claim 6, the advantage is obtained that the user, when buying a packing unit, at the same time purchases a number of standard batteries with tags and can use them in different apparatuses. Further application possibilities arise when a packing unit or an apparatus comprises a battery configuration having a number of tags and is placed in the communication range of a communication device, wherein the identification information items of all tags are read out. The combination of these identification information items could advantageously be evaluated by the communication device for specific applications.

According to the measures of claim 7, the advantage is obtained that the tag—for example as a replacement for a barcode on the packing unit—can also be used for stocktaking and payment. As soon as the standard battery together with tag is inserted into an apparatus of the user after purchase, the tag fulfills the task required by the respective application. The tag can thus be used advantageously in a number of ways.

According to the measures of claims 11 and 13, the advantage is obtained that a device (e.g. DVD+RW, television set, radio, etc.) which has a communication device, in order to make it possible to identify the user and to ensure specific features (e.g. customization of user settings), is purchased together with standard batteries of one or more different commercially available standard types of battery in a sales unit. The purchaser of the sales unit and subsequent user of the device thus advantageously receives suitable standard batteries together with tags at the same time, in order to be able to select one of his personal products (e.g. watch, pocket calculator, etc.) for identification with respect to the apparatus and supply it with power from the standard batteries.

According to the measures of claim 15, the advantage is obtained that the user—for example for an existing system of communication devices—can use any product for identification, wherein he need only insert a standard battery according to the invention, together with tag, into the product.

The invention will be further described with reference to examples of embodiments shown in the drawings to which, however, the invention is not restricted.

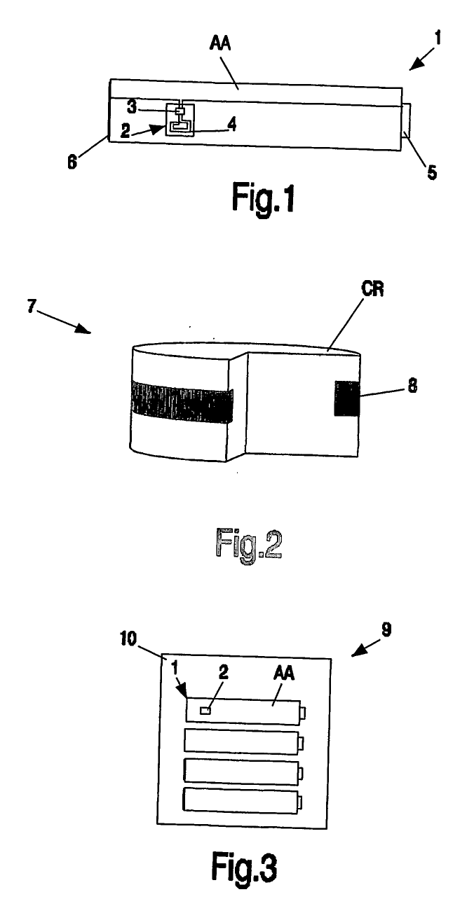

FIG. 1 shows a standard battery with a tag, which is connected to a plus contact and to a minus contact of the standard battery.

FIG. 2 shows a round cell, on the periphery of which a tag is provided.

FIG. 3 shows a packing unit in which four standard batteries are offered for sale together, wherein a tag is fitted on the casing of one of the standard batteries.

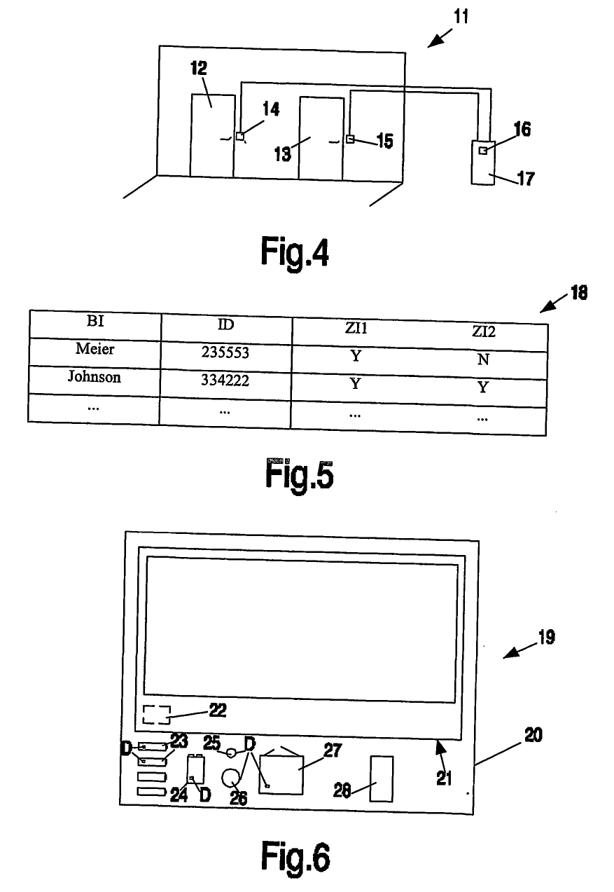

FIG. 4 shows an access control system.

FIG. 5 shows an access control table which is stored in a system computer of the access control system.

FIG. 6 shows a sales unit which comprises a television set and standard batteries according to five different standard types of battery.

FIG. 1 shows a battery configuration 1 which is formed by a standard battery AA of the commercially available standard type of battery mignon AA and a tag 2 fitted to the casing of the standard battery AA. The tag 2 is formed by a controller 3 and an antenna 4 and is designed for contactless communication with a communication device, as has been known for a long time. The tag 2 is furthermore connected to a plus contact 5 and to a minus contact 6 of the standard battery AA.

As a result, the situation is advantageously achieved that the tag 2 is supplied at least temporarily with power from the standard battery AA. The tag 2 could for example be operated by an electromagnetic field of the communication device for the time being in a passive operating mode and be placed in an active operating mode only for specific operating states (e.g. for the transmission of data), in which active operating mode the power for operating the tag 2 is used from the standard battery AA.

The controller 3 has a logic circuit and storage means, where an identification information item ID can be stored in the storage means. In this case, the identification information item ID can be stored at the time of manufacture of the tag 2—for example in the form of a serial number of the tag 2—or can be stored at a later point in time, during operation of the tag 2 in an apparatus.

In one step of manufacturing the battery configuration 1, the tag 2 has been attached to an adhesive film, which adhesive film—not shown in greater detail in FIG. 1—has been stuck to the standard battery AA. As a result, particularly simple and cost-effective manufacture of the battery configuration 1 is obtained. In addition, the advantage is obtained that the contactlessly communicating tag 2 extends over a particularly large communication range, since the casing does not screen the electromagnetic field.

It may be mentioned that a tag fitted to a standard battery can also communicate with a communication device over a communication interface that requires contact. In this case, a contact bank would be fitted on the controller, over which contact bank the controller could communicate with the communication device via contact pins fitted in the battery compartment of an apparatus or else directly via contact pins of the communication device that extend up to the contact bank of the standard battery. However, contact-requiring communication over the plus contact and/or the minus contact of the standard battery would be particularly advantageous if the tag is connected to these contacts.

FIG. 2 shows a battery configuration 7 in which the standard battery is formed by a round cell CR of the commercially available standard type of battery CR1025 and a tag 8. In order not to change the mechanical dimensions of the round cell CR with respect to the standard type of battery CR1025, the tag 8 has been designed as a tag 8 which surrounds the periphery of the round cell CR. This is made possible on the one hand by virtue of the smallness of the controller that is formed by an integrated circuit and on the other hand by virtue of an antenna that is wound around the periphery of the round cell.

FIG. 3 shows a packing unit 9 for a battery configuration 1 as shown in FIG. 1, where only one of the four standard batteries AA accommodated in the packing unit 9 has a tag 2. The four standard batteries are fastened to cardboard packaging 10 by means of a film, as is generally known. The document U.S. Pat. No. 4,827,395, the disclosure of which is incorporated into the disclosure of the present document, discloses a stocktaking and payment system using tags attached to products. In this case, as a replacement for a barcode, a tag is fitted to each product (e.g. sugar, salt, etc.), which tag can be interrogated at any time by a communication device in order to determine the current level of stock or in order to ascertain which products the customer would like to buy.

Advantageously, the tag contained in the battery configuration can additionally also be used for such stocktaking and payment systems, which is why the packing unit does not require any additional tag for this purpose. However, the essential advantage of the battery configuration according to the invention is that any apparatuses can be used for communication/identification, as described in more detail below.

FIG. 4 shows an access control system 11 which controls access to a first room located behind a door 12 and a second room located behind a door 13. The access control system 11 has three communication devices 14, 15 and 16 and a system computer 17, which are connected by means of cable connections. The communication devices 14, 15 and 16 are designed to contactlessly interrogate an identification information item ID and to check access authorizations.

According to one application example of the access control system 11, Mr. Johnson is to receive the access authorization for both rooms. Mr. Johnson has already been using his Personal Digital Assistant (PDA) for a relatively long time and he enjoys doing so; his PDA is supplied with power by three standard batteries of the standard type of battery CR1616. Since Mr. Johnson always carries his PDA with him, he would like to use this to identify himself to the access control system 11. To do this, Mr. Johnson correspondingly proceeds with an identification method and purchases a battery configuration which is formed by at least one standard battery of the standard type of battery CR1616 and at least one tag that is connected to one of these standard batteries.

He then inserts the three new standard batteries into his PDA, with at least one of these standard batteries having a tag. In an installation step, Mr. Johnson goes to the system computer 17, in which an access control table 18 as shown in FIG. 5 is stored. Mr. Johnson identifies himself to the system computer 17 in any other way (e.g. 1. the system administrator operating the system computer knows Mr. Johnson; 2. Mr. Johnson enters a secret numerical code using a keypad; 3. Mr. Johnson identifies himself using a smartcard, etc.) and holds his PDA in the communication range of the communication device 16. The identification information item ID stored in the tag of the standard battery of the PDA is then stored for the user information item BI and access control information item ZI1 and Z12 already stored by the system administrator. After this installation step, Mr. Johnson can gain access to both rooms by carrying his PDA at any time past the communication devices 14 and 15.

The advantage is thereby obtained that Mr. Johnson does not additionally need to carry any smartcard provided for the access control system 11 or any other identification means in order to gain access to the two rooms. Rather, Mr. Johnson can use his PDA for this purpose, which he always carries with him anyway. If the standard batteries in Mr. Johnson's PDA are empty, then he can simply purchase a new battery configuration and let the access control system 11 know the identification information item ID stored in the tag in a new installation step.

It would also be possible to always leave the identification information item ID in the access control table 18 the same and to store this in each case in the storage means of the tag which is provided in the battery configuration used by Mr. Johnson. It would also be possible for the system administrator of the access control system 11 to make available battery configurations of different standard types of battery and to hand out the corresponding standard type of battery CR1616 to Mr. Johnson and in the process also enter the identification information item ID in the access control table 18.

It may be mentioned that Mr. Johnson could also use a large number of other apparatuses for identification with respect to the access control system 11. For example, he could use his hearing aid, his CD walkman, his pocket calculator, his watch, his flashlight, his electric door opener for his car/garage, and many other apparatuses which are supplied with power by standard batteries. It is also particularly advantageous that all that is required is for the battery configuration to be moved from one apparatus into another apparatus in order then to use the other apparatus for identification/communication. In this connection, the person skilled in the art will be aware of a large number of applications (e.g. electronic car park tickets, electronic entrance tickets, electronic wallets, etc.) using tags.

FIG. 6 shows a sales unit 19 which is formed by a cardboard box 20 in which an apparatus that is offered for sale—a television set 21—is contained, said apparatus comprising a communication device 22. The communication device 22 is designed for contactless communication with tags D in order to identify users of the television set 21 to which the identification information items ID stored in the tags D have been assigned. As soon as a user of the television set 21 is identified, customized user settings are carried out. By way of example, the volume and color intensity of the television set 21 are adjusted to how the respective user prefers them. Likewise, certain preferred teletext pages are stored and a given transmitter sequence is set.

The sales unit 19 advantageously additionally has a number of battery configurations 23, 24, 25, 26 and 27, which in each case correspond to standard batteries of various standard types of battery. The user of the television set 21 can thus advantageously use a product of his choice (e.g. his watch) to identify himself to the television set 21 and insert the suitable battery configuration (e.g. round cell 25 with tag D) into this product. After an installation step, in which the user enters his personal user settings using the identification information item ID stored in the tag D of the round cell 25, the user can use his watch for identification with respect to the television set 21. One of the battery configurations 23, 24, 25, 26 or 27 contained in the sales unit 19 can advantageously also correspond to the standard type of battery to be inserted into a remote control 28 contained in the sales unit 19. As a result, the remote control 28 of the television set 21 can advantageously be designed to communicate with the communication device 22.

A purchaser of the television device 21 can thus, in accordance with a provision method, purchase the sales unit 19 in a shop, take the sales unit 19 home (or have it delivered) and insert one of the battery configurations contained in the sales unit 19 into a product of his choice (e.g. watch, PDA, pocket calculator, walkman, etc.). Advantageously, the purchaser is thus completely free to choose which product he would like to use for identification with respect to the television set 21.

It may be mentioned that the term standard battery of a battery configuration according to the invention also encompasses a rechargeable standard battery, that is to say an accumulator. As a result, the advantage is obtained that the installation step need only be carried out once at the time of first use of the accumulator, since this only needs to be charged up rather than replaced like a battery.

The many varied type designations of commercially available standard types of battery are known to the person skilled in the art, such as those that are listed in sales catalogs. A list of the individual standard types of battery will therefore not be given in the present text, with all those standard types of battery mentioned in sales catalogs being incorporated into the disclosure of this document.

It may be mentioned that sales units may contain many different apparatuses which can communicate with tags contained in the battery configurations supplied with them by means of a communication device that is contained in the apparatus or can be connected to the apparatus.

It may be mentioned that data (e.g. data corresponding to amounts of money, data corresponding to settings of the apparatus, etc.) can be read from the tag of the battery configuration by the communication device, and where appropriate amended data can in turn be written to the tag.

A battery configuration according to the invention may comprise one standard battery and one or more tags or of one tag and one or more standard batteries or of a number of standard batteries and a number of tags.

1. A battery configuration having at least one battery and a tag connected to the at least one battery, for storing an identification information item, wherein the battery is formed by a standard battery of a commercially available standard type of battery.

2. A battery configuration as claimed in claim 1, wherein the tag is connected to a plus contact and to a minus contact of the standard battery in order to supply the tag at least temporarily with power from the standard battery for the operation of said tag.

3. A battery configuration as claimed in claim 1, wherein the tag is designed for communicating at least the identification information item to a communication device with and/or without contact.

4. A battery configuration as claimed in claim 1, wherein the tag is connected to the casing of the standard battery.

5. A battery configuration as claimed in claim 1, wherein the battery configuration has at least two standard batteries of the same standard type of battery, which are together provided in a packing unit, and wherein the at least one tag is assigned to at least one of these standard batteries.

6. A battery configuration as claimed in claim 5, wherein a tag is assigned to each of the standard batteries provided in the packing unit.

7. A battery configuration as claimed in claim 5, wherein the tag can be used for the electronic stocktaking of and/or payment for the packing unit in a shop.

8. A battery configuration as claimed in claim 1, wherein the standard battery corresponds to the standard type of battery micro mono For baby or to one of the commercially available standard types of round cell batteries.

9. A packing unit for a battery configuration having at least one battery and a tag D, connected to the at least one battery, for storing an identification information item wherein the battery is formed by a standard battery of a commercially available standard type of battery.

10. A packing unit as claimed in claim 9, wherein the battery configuration has at least two standard batteries of the same standard type of battery, which are together provided in a packing unit, and wherein the at least one tag is assigned to at least one of these standard batteries.

11. A sales unit for selling an apparatus having a communication device by means of which it is possible to identify a user of the apparatus, comprising
the apparatus having the communication device and a battery configuration having at least one standard battery of at least one commercially available standard type of battery and a tag, connected to the battery, for storing an identification information item, wherein the at least one standard battery is provided for supplying a product of the user with power and the tag connected to the standard battery is provided to identify the user of the apparatus during communication with the communication device.

12. A sales unit Has claimed in claim 11, wherein standard batteries of at least two different standard types of battery and associated tags are provided in the sales unit.

13. A provision method for providing an apparatus having a communication device by means of which it is possible to identify a user of the apparatus, wherein the following steps are carried out:
provision of a sales unit which comprises the apparatus that is to be provided and a battery configuration wherein the battery configuration comprises at least one standard battery of at least one commercially available standard type of battery and a tag assigned to the standard battery, for storing an identification information item;
delivery of the sales unit (to the future user of the apparatus;
insertion of the at least one standard battery into a product of the user of the apparatus, in order to make it possible to identify the user of the apparatus during communication between the communication device of the apparatus and the tag assigned to the standard battery, on the basis of the identification information item that can be stored in the tag.

14. A provision method as claimed in claim 13, wherein standard batteries of at least two different standard types of battery and associated tags are provided in the sales unit.

15. An identification method for identifying a user of a product, wherein the following steps are carried out:
purchasing of a battery configuration by the user,
wherein the battery configuration comprises at least one standard battery of at least one commercially available standard type of battery, which can be inserted into the product, and a tag connected to the standard battery, for storing an identification information item;
insertion of the at least one standard battery into the product, in order to supply the product at least temporarily with power from the standard battery;
identification of the user of the product during communication between a communication device and the tag assigned to the standard battery, on the basis of an identification information item that can be stored in the tag.

16. An identification method as claimed in claim 15, wherein, in an installation step following identification of the user by the communication device in any other way the identification information item stored in the tag is stored in a manner assigned to a user information item in the communication device.
